(19) United States
(12) Patent Application Publication
(10) Pub. No.: US 2024/0169952 A1
(43) Pub. Date: May 23, 2024

(54) DISPLAY PANEL AND DISPLAY DEVICE

(71) Applicant: Guangzhou China Star Optoelectronics Semiconductor Display Technology Co., Ltd., Guangzhou, Guangdong (CN)

(72) Inventor: Qian LIU, Guangzhou, Guangdong (CN)

(21) Appl. No.: 17/755,301

(22) PCT Filed: Apr. 13, 2022
(86) PCT No.: PCT/CN2022/086652

§ 371 Date: Apr. 26, 2022

(30) Foreign Application Priority Data
Mar. 30, 2022 (CN) 202210329492.3

(51) Int. Cl. G09G 3/36

(52) U.S. Cl. CPC G09G 3/3688; G09G 3/3614; G09G 2300/0426; G09G 2300/0842; G09G 2310/0297; G09G 2320/0233

(57) ABSTRACT

The present disclosure discloses a display panel and a display device. The display panel includes a plurality of data lines, a Demux circuit, a plurality of signal transmission lines and a plurality of sub-pixels. The Demux circuit includes at least two control signal lines and a plurality of control units. A pixel electrode and a common electrode are laminated and insulated in each of the sub-pixels to form a storage capacitor. A capacitance value of the storage capacitor and/or a common voltage connected with the common electrode of the sub-pixel are/is adjusted according to the intersection times of the corresponding data line with the plurality of control signal lines.

### TECHNICAL FIELD

The present disclosure relates to a display technology field, and in particular to a display panel and a display device.

### BACKGROUND

Currently, in order to reduce the number of output channels of a driving chip in a design process of the display panel, a Demux (Demultiplexer) circuit is usually added into a driving circuit of the display panel, so that the number of the output channels of a source driving chip is reduced manyfold. A plurality of control signal lines need to be disposed for the Demux circuit, to drive the Demux circuit to operate in a time division manner.

### Technical Problems

A coupling capacitance is generated at a place where the data line intersects with the control signal line, and each of different data lines intersects with a plurality of control signal lines for a different number of times, so that data voltages received by the different data lines are subjected to different coupling effects from the control signal lines, which causes a charging difference among a plurality of sub-pixels, thereby affecting a display uniformity.

### Technical Solutions to the Problem

The present disclosure provides a display panel and a display device, so as to resolve such a technical problem that the data voltages received from different data lines in an existing display panel are subjected to different coupling effects from the control signal lines, which causes a charging difference among the plurality of sub-pixels, thereby affecting the display uniformity.

The present disclosure provides a display panel including:
a plurality of data lines arranged in a first direction;
a Demux circuit including at least two control signal lines and a plurality of control units, wherein, the at least two control signal lines are arranged in a second direction, each of the control units is electrically connected to corresponding one of the control signal lines and corresponding one of the data lines, and the first direction intersects with the second direction;
a plurality of signal transmission lines arranged in the first direction, each of the signal transmission lines being electrically connected to the at least two control units; and
a plurality of sub-pixels arranged in an array, wherein each of the sub-pixels includes a pixel electrode and a common electrode, the pixel electrode and the common electrode are laminated and insulated to form a storage capacitor, and each of the pixel electrodes is electrically connected to a corresponding data line;
wherein, the data lines are disposed at a different layer from the control lines, a portion of the data lines intersects with at least one of the control signal lines, and a capacitance value of the storage capacitor and/or a common voltage connected with the common electrode of the sub-pixel are/is adjusted according to the intersection times of the corresponding data line with the plurality of control signal lines.

Optionally, in some embodiments of the present disclosure, the sub-pixels in the same column are electrically connected to the same data line in the first direction, and the capacitance value of the storage capacitor and the common voltage connected with the common electrode of each of the sub-pixels in the same column are equal.

Optionally, in some embodiments of the present disclosure, in the first direction, two adjacent data lines of the data lines are configured to transmit data voltages having opposite polarities, two adjacent sub-pixels of the sub-pixels have opposite polarities, and the capacitance value of the storage capacitor and the common voltage connected with the common electrode of each of the sub-pixels controlled by the same control signal line are equal.

Optionally, in some embodiments of the present disclosure, the plurality of data lines include a first data line intersecting with m control signal lines of the control signal lines and a second data line intersecting with n control signal lines of the control signal lines, wherein 0≤m<n;
when a positive polarity data voltage is outputted from the signal transmission line, the capacitance value of the storage capacitor of the sub-pixel connected to the first data line is less than the capacitance value of the storage capacitor of the sub-pixel connected to the second data line; and
when a negative polarity data voltage is outputted from the signal transmission line, the capacitance value of the storage capacitor of the sub-pixel connected to the first data line is greater than the capacitance value of the storage capacitor of the sub-pixel connected to the second data line.

Optionally, in some embodiments of the present disclosure, an area of the common electrode of the storage capacitor with a larger capacitance value is greater than the area of the common electrode of the storage capacitor with a smaller capacitance value.

Optionally, in some embodiments of the present disclosure, the plurality of common electrodes are connected with the same common voltage.

Optionally, in some embodiments of the present disclosure, each of common voltage wirings includes a first wiring and a plurality of second wiring connected to the first wiring, the first wiring extends in the first direction, the plurality of second wirings are disposed in the first direction, each of the second wirings is disposed between two adjacent columns of the sub-pixels, and the sub-pixels in the same column are electrically connected to the same second wiring.

Optionally, in some embodiments of the present disclosure, the plurality data lines include a first data line intersecting with m control signal lines of the control signal lines and a second data line intersecting with n control signal lines of the control signal lines, and the common voltage connected with the common electrode of the sub-pixel connected to the first data line is greater than the common voltage connected with the common electrode of the sub-pixel connected to the second data line, wherein, 0≤m<n.

Optionally, in some embodiments of the present disclosure, the display panel further includes a plurality of common voltage wirings, wherein each of the common voltage wirings transmits a different common voltage, and the number of the common voltage wirings is the same as that of the control signal wirings; and
a plurality of the sub-pixels controlled by the same control signal line are electrically connected to the same common voltage wiring.

Optionally, in some embodiments of the present disclosure, each of the control units includes a thin film transistor, a gate thereof is electrically connected to a corresponding control signal line, a source thereof is electrically connected to a corresponding signal transmission line, and a drain thereof is electrically connected to a corresponding data line; and
channel aspect ratios of the thin film transistors in the plurality of control units are equal.

Optionally, in some embodiments of the present disclosure, two adjacent data lines of the data lines are configured to transmit data voltages having opposite polarities, each of the signal transmission lines is configured to transmit data voltages having the same polarity, and each of the data lines is electrically connected to a corresponding signal transmission line via one of the control units.

Optionally, in some embodiments of the present disclosure, two adjacent data lines of the data lines are configured to transmit data voltages having opposite polarities, each of the signal transmission lines is configured to alternately transmit data voltages having opposite polarities, and k adjacent data lines of the data lines are electrically connected to the same signal transmission line via a corresponding control unit, wherein k is greater than or equal to 2.

Correspondingly, the present disclosure further provides a display device, including a display panel and a source driving chip, wherein the source driving chip is configured to provide a data voltage to the display panel, and the display panel includes:
a plurality of data lines arranged in a first direction;
a Demux circuit including at least two control signal lines and a plurality of control units, wherein, the at least two control signal lines are arranged in a second direction, each of the control signal units is electrically connected to corresponding one of the control signal lines and corresponding one of the data lines, and the first direction intersects the second direction;
a plurality of signal transmission lines arranged in the first direction, wherein each of the signal transmission lines is electrically connected to the at least two control units; and
a plurality of sub-pixels arranged in an array, wherein each of the sub-pixels includes a pixel electrode and a common electrode, the pixel electrode and the common electrode are laminated and insulated to form a storage capacitor, and each of the pixel electrodes is electrically connected to a corresponding data line;
wherein, the data lines are disposed at a different layer from the control lines, a portion of the data lines intersects with at least one of the control signal lines, and a capacitance value of the storage capacitor and/or a common voltage connected with the common electrode of the sub-pixel are/is adjusted according to the intersection times of the corresponding data line with the plurality of control signal lines.

The sub-pixels in the same column are electrically connected to the same data line in the first direction, and the capacitance value of the storage capacitor and the common voltage connected with the common electrode of each of the plurality of the sub-pixels in the same column are equal.

Optionally, in some embodiments of the present disclosure, two adjacent data lines of the data lines are configured to transmit data voltages having opposite polarities, two adjacent sub-pixels of the sub-pixels have opposite polarities, and the capacitance value having the storage capacitor and the common voltage connected with the common electrode of each of the sub-pixels controlled by the same control signal line are equal.

Optionally, in some embodiments of the present disclosure, the plurality of data lines include a first data line intersecting with m control signal lines of the control signal lines and a second data line intersecting with n control signal lines of the control signal lines, wherein 0≤m<n;
when a positive polarity data voltage is outputted from the signal transmission line, the capacitance value of the storage capacitor of the sub-pixel connected to the first data line is less than the capacitance value of the storage capacitor of the sub-pixel connected to the second data line; and
when a negative polarity data voltage is outputted from the signal transmission line, the capacitance value of the storage capacitor of the sub-pixel connected to the first data line is greater than the capacitance value of the storage capacitor of the sub-pixel connected to the second data line.

Optionally, in some embodiments of the present disclosure, the plurality of common electrodes are connected with the same common voltage.

Optionally, in some embodiments of the present disclosure, an area of the common electrode of the storage capacitor with a larger capacitance value is greater than an area of the common electrode of the storage capacitor with a smaller capacitance value.

Optionally, in some embodiments of the present disclosure, each of common voltage wirings includes a first wiring and a plurality of second wiring connected to the first wiring, the first wiring extends in the first direction, the plurality of second wirings are arranged in the first direction, each of the second wirings is disposed between two adjacent columns of the sub-pixels, and the sub-pixels in the same column are electrically connected to the same second wiring.

Optionally, in some embodiments of the present disclosure, the plurality data lines include a first data line intersecting with m control signal lines of the control signal lines and a second data line intersecting with n control signal lines of the control signal lines, and the common voltage connected with the common electrode of the sub-pixel connected to the first data line is greater than the common voltage connected with the common electrode of the sub-pixel connected to the second data line, wherein, 0≤m<n.

### Beneficial Effects

The present disclosure provides a display panel and a display device. The display panel includes a plurality of data lines, a Demux circuit, a plurality of signal transmission lines and a plurality of sub-pixels. A portion of the data lines are intersected at a different layer from at least one of the control signal lines, and a capacitance value of the storage capacitor and/or a common voltage connected with the common electrode of the sub-pixel are/is adjusted according to the intersection times of the corresponding data line with the plurality of control signal lines. The present disclosure can adjust the capacitance value of the storage capacitor of each of the sub-pixels and/or the common voltage connected to the common electrode according to different coupling effects on the data voltages received from different data lines, so as to compensate for a difference of data voltages due to the different coupling effects. As a result, a charging difference among the sub-pixels can be reduced, thereby improving a display uniformity of the display panel.

### BRIEF DESCRIPTION OF THE DRAWINGS

In order to more clearly illustrate the technical solutions in embodiments of the present disclosure, the accompanying drawings depicted in the description of the embodiments will be briefly described below. It will be apparent that the accompanying drawings in the following description are merely some embodiments of the present disclosure, and other drawings may be obtained from these drawings without creative effort by those skilled in the art.

FIG. 1 is a schematic diagram of a first structure of a display panel according to the present disclosure;

FIG. 2 is an equivalent circuit diagram at A in FIG. 1 according to the present disclosure;

FIG. 3 is a schematic diagram of a relationship between a data voltage and a feeder voltage according to the present disclosure;

FIG. 4 is a schematic diagram of a second structure of a display panel according to the present disclosure;

FIG. 5 is a schematic diagram of a third structure of a display panel according to the present disclosure;

FIG. 6 is a schematic diagram of a fourth structure of a display panel according to the present disclosure;

FIG. 7 is a schematic structural diagram of a display device according to the present disclosure.

### EMBODIMENTS OF THE PRESENT DISCLOSURE

Technical solutions in embodiments of the present disclosure will be clearly and completely described below in conjunction with drawings in the embodiments of the present disclosure. Obviously, the described embodiments are only a part of embodiments of the present disclosure, rather than all the embodiments. Based on the embodiments in the present disclosure, all other embodiments obtained by those skilled in the art without creative work fall within the protection scope of the present disclosure.

In the description of the present disclosure, it should be understood that the terms “first” and “second” are for illustrative purposes only and are not to be construed as indicating or imposing a relative importance or implicitly indicating the number of technical features indicated. Thus, a feature that limited by “first” and “second” may expressly or implicitly include at least one of the features, and therefore cannot be construed as a limitation on the present disclosure.

The present disclosure provides a display panel and a display device, which are described in detail below. It should be noted that the description order of the following embodiments of the present disclosure is not intended to limit the preferred order of the embodiments.

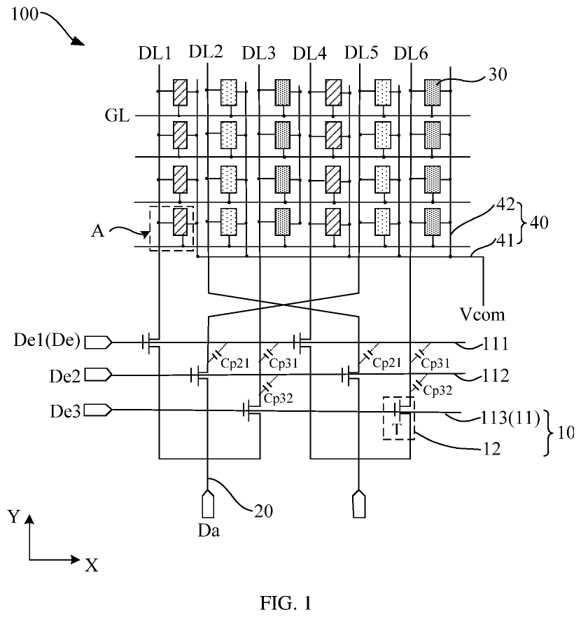

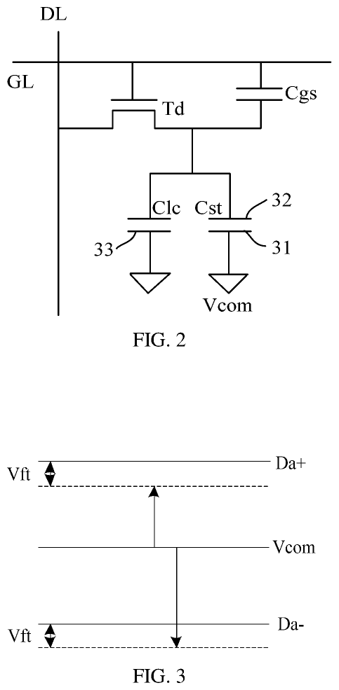

Please refer to FIGS. 1 and 2, FIG. 1 is a schematic diagram of a first partial structure of a display panel according to the present disclosure. FIG. 2 is an equivalent circuit diagram at A in FIG. 1 according to the present disclosure. In an embodiment of the present disclosure, the display panel 100 includes a plurality of data lines DL, a Demux circuit 10, a plurality of signal transmission lines 20, and a plurality of sub-pixels 30.

The plurality of data lines are arranged in a first direction X. The Demux circuit 10 includes at least two control signal lines 11 and a plurality of control units 12. The at least two control signal lines 11 are arranged in a second direction Y. Each of the control units 12 is electrically connected to a corresponding control signal line 11 and a corresponding data line DL. The first direction X intersects the second direction Y. A plurality of signal transmission lines 20 are arranged in a first direction X, and each of the signal transmission lines 20 is electrically connected to at least two control units 12. A plurality of sub-pixels 30 are arranged in an array. Each of the sub-pixels 30 includes a pixel electrode 32 and a common electrode 31. The pixel electrode 32 and the common electrode 31 are laminated and insulated to form a storage capacitor, Cst. Each of the pixel electrodes 32 is electrically connected to a corresponding data line DL.

The data line DL are disposed at a different layer from the control signal line 11. A portion of the data lines DL may be intersected at a different layer from at least one of the control signal lines 11. A capacitance value of the storage capacitor Cst and/or a common voltage Vcom connected with the common electrode 31 of the sub-pixel 30 can be adjusted according to the intersection times of the corresponding data line DL with the plurality of control signal lines 11. It should be noted that each of the data lines DL does not intersect or intersects with the same control signal line 11 only once in a conventional design.

Due to a process reason or a pixel arrangement design, the first direction X and the second direction Y may be perpendicularly intersected, or may be only intersected but they are not perpendicular. The accompanying drawings are merely examples and cannot be understood as a limitation on the present disclosure.

The Demux circuit 10 can include two control signal wirings 11, three control signal wirings 11, four control signal wirings 11, and the like, which are not described in detail herein. A control signal De is outputted from each of the control signal lines 11 in a time division manner, so as to control communication between the signal transmission line 20 and a corresponding data line DL. The more the number of the control signal lines 11 is, the smaller the number of corresponding signal transmission lines 20 is. The number of the data lines DL may be set according to a size of the display panel 100 and a resolution specification of the display panel 100. This is not specifically limited in the present disclosure.

The display panel 100 can further include a plurality of scanning lines GL. The plurality of scanning lines GL are arranged in the second direction Y. Each of the pixel electrodes 30 is electrically connected to a corresponding data line DL and a corresponding scanning line GL.

Generally, each of the sub-pixels 30 includes a sub-pixel driving circuit. The sub-pixel driving circuit includes a switching transistor Td, a storage capacitor Cst, and a liquid crystal capacitor Clc. Each of the sub-pixels 30 is electrically connected to a corresponding scanning line GL and a corresponding data line DL via the switching transistor Td. Since the data line DL and the scan line GL are intersected with each other, there is a coupling capacitance, that is, a gate-source capacitor Cgs, between the data line DL and the scan line GL. Two plates of the storage capacitor Cst are respectively a common electrode 31 (an array side common electrode) and a pixel electrode 32. Two plates of the liquid crystal capacitor Clc are respectively a color filter side common electrode 33 and a pixel electrode 32.

Certainly, in some display panels 100, such as an FFS (Fringe Field Switching) display panel, the sub-pixel 30 includes only the storage capacitor Cst, and does not include the liquid crystal capacitor Clc. FIG. 2 is merely an example and cannot be understood as a limitation on the present disclosure.

In the display panel 100 of the embodiment of the present disclosure, the capacitance value of the storage capacitor Cst and/or the common voltage Vcom connected to the common electrode 31 of the sub-pixel 30 can be adjusted according to the different coupling effects of the data voltages Da received from different data lines DL, so as to compensate for a difference of the data voltage Da due to the different coupling effects. As a result, a charging difference among the plurality of sub-pixels 30 can be reduced, thereby improving a display uniformity of the display panel 100.

Specifically, the technical solutions in the embodiments of the present disclosure are analyzed as follows.

It should be understood that, firstly, there is a coupling capacitance at a place where the data line DL intersects with the control signal line 11. Since the control signal lines 11 are enabled row by row, a control signal De output from at least one of the control signal line 11 is switched between a high level and a low level, which produces a coupling effect on the data voltage Da transmitted on the data line DL, resulting in a change of a voltage value of the data voltage Da. Secondly, the different data lines DL can be controlled by the different control signal lines 11, and the plurality of control signal lines 11 are arranged in the second direction Y. Since the number of the control signal lines 11 that intersects with each of different data lines DL is different, the produced coupling capacitances are also different. Due to the different coupling capacitances, the same data voltages Das are different when transmitted to the data line DL under the effect of the control signal De.

For example, as shown in FIG. 1, since the first data line DL1 does not intersect with the plurality of control signal lines 11, the first data line DL1 is not affected by the coupling capacitance. A second data line DL2 intersects with a first control signal line 111. There is a first coupling capacitance Cp21 between the second data line DL2 and the first control signal line 111. A third data line DL3 intersects with the first control signal line 111 and a second control signal line 112, respectively. There is a second capacitive coupling capacitance Cp31 between the third data line DL3 and the first control signal line 111. There is a third coupling capacitance Cp32 between the third data line DL3 and the second control signal line 112. Therefore, a coupling effect on the first data line DL1 is less than the coupling effect on the second data line DL2. The coupling effect on the second data line DL2 is less than the coupling effect on the third data line DL3.

Similarly, the more the number of the control signal lines 11 is, the greater the coupling effect on the data lines DL controlled by the control signal lines 11 farther away from the data lines DL is. The plurality of data lines DL controlled by the same control signal line 11 are subjected to the same coupling effect. This is not repeatedly described hereinafter.

Therefore, even if the same data voltages Das are outputted from the signal transmission lines 20, the final data voltages Das transmitted to the different data lines DL are different under the coupling effect of the control signal De, resulting in an uneven charging among the plurality of sub-pixels 30.

Specifically, referring to FIGS. 1 to 3, FIG. 3 is a schematic diagram of a relationship between a data voltage and a feeder voltage according to the present disclosure. A solid line in the figure represents an ideal voltage of the sub-pixel 30, that is, the data voltage Da output from the signal transmission line 20. A dashed line represents an actual voltage of the sub-pixel 30, that is, the data voltage Da that is output to the data line DL after subjected to the couple effect. The feeder voltage Vft is a difference between the ideal voltage and the actual voltage. A positive polarity data voltage Da+ and a negative polarity data voltage Da− at the same gray scale are symmetrical with respect to the common voltage Vcom. It can be known that the difference of the feeder voltage Vft corresponds to a display brightness difference of the sub-pixel 30. For a positive polarity sub-pixel, the larger the feeder voltage Vft is, the darker the pixel is. For a negative polarity sub-pixel, the larger the feeder voltage Vft is, the brighter the pixel is.

That is, when the same data voltages Das are outputted from the signal transmission line 20, the data voltage Da actually received by the sub-pixel 30 controlled by the control signal line 11 close to the data line DL is greater than the data voltage Da actually received by the sub-pixel 30 controlled by the control signal line 11 far away from the data line DL, so that the pixel electrode 32 of the sub-pixel 30 is charged to different voltages.

In this regard, it should be understood that the capacitance value of the storage capacitor Cst may affect a charging rate of the sub-pixel 30, thereby affecting a brightness of the sub-pixel 30. A voltage value of the common voltage Vcom connected with the common electrode 31 will affect a deflection angle of a liquid crystal, thereby affecting the brightness of the sub-pixel 30.

Therefore, the embodiment of the present disclosure can adjust the capacitance value of the storage capacitor Cst and/or the common voltage Vcom connected with the common electrode 31 of the sub-pixel 30, so as to compensate for a difference of the data voltage Da due to the different coupling effects. As a result, a charging difference among the plurality of sub-pixels 30 can be reduced, thereby improving a display uniformity of the display panel 100.

It should be noted that, in order to avoid that a liquid crystal molecule cannot be rotated according to a change of an electric field due to a damage of a characteristic of the liquid crystal molecule, the data voltages Das having positive and negative polarities being opposite need to be applied to the liquid crystal to drive the liquid crystal to be rotated. Therefore, the polarities being opposite mentioned in the embodiment of the present disclosure means that polarities of the data voltages Da received by the two sub-pixels 30 are opposite. A positive polarity sub-pixel refers to a sub-pixel 30 that receives the positive polarity data voltage Da+. A negative polarity sub-pixel refers to a sub-pixel 30 that receives the negative polarity data voltage Da−.

In the embodiment of the present disclosure, each of the control units 12 includes at least one thin film transistor T. A gate of the thin film transistor T is electrically connected to the corresponding control signal line 11. A source of the thin film transistor T is electrically connected to the corresponding signal transmission line 20. A drain of the thin film transistor T is electrically connected to the corresponding data line DL. Certainly, in another embodiment of the present disclosure, the control unit 12 may also include a plurality of thin film transistors T or another element, as long as the communication between the data line DL and the signal transmission line 20 can be controlled.

The thin film transistor T in the embodiment of the present disclosure may be one or more of a low-temperature polysilicon thin film transistor, an oxide semiconductor thin film transistor, or an amorphous silicon thin film transistor. In addition, each thin film transistor T may be a P-type transistor or an N-type transistor. Further, the thin film transistors T in the embodiments of the present disclosure may be configured as the same type of transistor, so as to avoid adverse impact of differences between different types of thin film transistors T on a touch sensitivity.

In an embodiment of the present disclosure, channel aspect ratios of the thin film transistors T in the plurality of control units 12 are equal. It should be understood that the channel aspect ratio of the thin film transistor T affects a resistance of the thin film transistor T, that is, also affects a conductivity of the thin film transistor T. The embodiment of the present disclosure can further reduce a difference between the data voltages Da transmitted to the respective data lines DL by configuring the channel aspect ratio of each of the thin film transistors T to be equal, thereby improving the display uniformity.

In the following embodiments of the present disclosure, an example that the Demux circuit includes three control signal lines 11 and each of the control units 12 includes one N-type thin film transistor is taken, which should not be understood as a limitation of the present disclosure.

Specifically, the first control signal line 111 outputs a first control signal De1 in the second direction Y. The second control signal line 112 outputs a second control signal De2. The third control signal line 113 outputs a third control signal De3.

In the embodiment of the present disclosure, any of the three data lines DL may be electrically connected to the same signal transmission line 20 via corresponding one of the three control units 12. The three control signal lines 11 respectively control the three control units 12 to be turned on in the time division manner. Certainly, any two of the data lines DL may be electrically connected to the same signal transmission line 20 via corresponding two of the control units 12. Any two of the three control signal lines 11 respectively control the two control units 12 to be turned on in the time division manner. Certainly, the foregoing two cases may be mixed. This is not specifically limited in the present disclosure.

Still referring to FIG. 1 and FIG. 2, in the embodiments of the present disclosure, the capacitance value of the storage capacitor Cst and the common voltage Vcom connected with the common electrode 31 of each of the sub-pixels 30 controlled by the same control signal line 11 are equal.

Each of the control signal lines 11 controls a switching state of the thin film transistor T connected to the control signal line 11, so as to control the communication between the data line DL and the signal transmission line 20. When the thin film transistor T is turned on, the data voltage Da can be charged to the corresponding sub-pixel 30 via the data line DL. Therefore, the sub-pixel 30 may be controlled by the control signal line 11.

It should be understood that each of the data lines DL that are communicated and controlled by the same control signal line 11 intersects with the plurality control signal lines 11 for the same times. For example, the first data line DL1 and the fourth data line DL4 do not intersect with the plurality of control signal lines 11. For another example, both the third data line DL3 and the sixth data line DL6 intersect with the plurality of control signal lines 11 twice. Therefore, the data voltage Da received by each of the sub-pixels 30 controlled by the same control signal line 11 is subjected to the same coupling effect.

Therefore, in the embodiment of the present disclosure, the capacitance value of the storage capacitor Cst and the common voltage Vcom connected with the common electrode 31 of each of the sub-pixels 30 controlled by the same control signal line 11 are equal, so that the plurality of pixels 30 controlled by the same control signal line 11 are uniformly charged when the feed voltages Vft are consistent.

Similarly, the data voltages Da received from the same data line DL are subjected to the same coupling effect. Therefore, the capacitance value of the storage capacitor Cst and the common voltage Vcom connected with the common electrode 31 of each of the sub-pixels 30 electrically connected to the same data line DL are equal.

Specifically, in the embodiments of the present disclosure, in the first direction X, the sub-pixels 30 in the same column are electrically connected to the same data line DL. The capacitance value of the storage capacitor Cst or the common voltage Vcom connected with the common electrode 31 of each of the plurality of sub-pixels 30 in the same column are equal.

As a result, the capacitance of the corresponding storage capacitor Cst and/or the common voltage Vcom received by the common electrode 31 may be adjusted in a unit of one column of sub-pixels 30, so as to simplify adjustment complexity.

Further, in the embodiment of the present disclosure, two adjacent data lines DL are configured to transmit the data voltage Da having opposite polarities. That is, the display panel 100 in the embodiment of the present disclosure adopts a column inversion driving mode, so as to improve a display quality of the display panel 100.

Each of the signal transmission line 20 is configured to transmit the data voltages Da having the same polarity. Each of the data lines DL is electrically connected to a corresponding signal transmission line 20 via one of the control units 12.

For example, in the first direction X, a positive polarity data voltage is outputted only from the first signal transmission line 20, and a negative polarity data voltage is outputted only from the second signal transmission line 20. In this case, in every six adjacent data lines DL, the first data line DL1, the third data line DL3, and the fifth data line are all connected to the first signal transmission line 20. The second data line DL2, the fourth data line DL4, and the sixth data line DL6 are all connected to the second signal transmission line 20. Therefore, the adjacent data lines DL are configured to transmit the data voltages Da having different polarities, while power consumption of the source driving chip that outputs the data signal Da can be reduced.

In the embodiment of the present disclosure, the sub-pixel 30 may be a red sub-pixel, a green sub-pixel, a blue sub-pixel, a white sub-pixel, a yellow sub-pixel, or the like. This is not specifically limited in the present disclosure. The display panel 100 provided in the present disclosure may adopt a standard RGB pixel arrangement architecture, a RGB PenTile pixel arrangement architecture, a RGB Delta pixel arrangement architecture, a RGBW pixel arrangement architecture, or the like, and may be specifically set according to a display requirement of the display panel 100.

For example, as shown in FIG. 1, the sub-pixel 30 is a red sub-pixel, a green sub-pixel, or a blue sub-pixel. In the same row of sub-pixels 30, a plurality of sub-pixels 30 are repeatedly arranged in any one of arrangement combinations such as RGB, RBG, BGR, BRG, GRB, and GBR. The sub-pixels 30 in the same column have the same color.

In the embodiment of the present disclosure, the plurality of data lines DL include the first data line and the second data line. The first data line intersects with m control signal lines 11. The second data line intersects with n control signal lines 11, where 0≤m<n. When the positive polarity data voltage is outputted from the signal transmission line 20, the capacitance value of the storage capacitor Cst of the sub-pixel 30 connected to the first data line is less than the capacitance value of the storage capacitor Cst of the sub-pixel 30 connected to the second data line. When the negative polarity data voltage is outputted from the signal transmission line 20, the capacitance value of the storage capacitor Cst of the sub-pixel 30 connected to the first data line is greater than the capacitance value of the storage capacitor Cst of the sub-pixel 30 connected to the second data line.

The values of m and n depend on the number of control signal lines 11. When three control signal lines 11 are provided, m may be 0 or 1, and n may be 1 or 2. For example, when m=0 and n=1, the first data line may be the first data line DL1 or the fourth data line DL4, and the second data line may be the second data line DL2 or the fifth data line DL5. For example, when m=0 and n=2, the first data line may be the first data line DL1 or the fourth data line DL4, and the second data line may be the third data line DL3 or the sixth data line DL3. For example, when m=1 and n=2, the first data line may be the first data line DL1 or the fifth data line DL5, and the second data line may be the third data line DL3 or the sixth data line DL3.

Referring to FIG. 1 to FIG. 3 again, it can be known from the foregoing that, for a positive polarity sub-pixel, the larger the feeder voltage Vft is, the darker the pixel is. For a negative polarity sub-pixel, the larger the feeder voltage Vft is, the brighter the pixel is.

Therefore, for the positive polarity sub-pixel, when the same positive-polarity data voltage Da is outputted from the signal transmission line 20, the data voltage Da transmitted on the first data line changes smallest, and the pixel is brightest. In this case, for the negative polarity sub-pixel, the data voltage Da transmitted on the second data line changes smallest, and the pixel is darkest.

Therefore, the embodiment of the present disclosure can adjust the capacitance value of the storage capacitor Cst of each of the sub-pixels 30 according to the polarity of the data voltage Da transmitted in the display panel 100, so as to compensate for a difference of the data voltages Da due to the different coupling effects, thereby improving the display uniformity of the display panel 100.

It should be understood that the capacitance value of the capacitor is mainly related to a dielectric constant of an insulation material between the two plates, a spacing between the two substrates, and a relative cross-sectional area between the two plates. Therefore, the capacitance value of the capacitor can be adjusted by adjusting the foregoing parameters. However, insulation materials and process conditions are usually the same in a panel process. Therefore, the dielectric constant of the insulation material between the two plates and the spacing between the two substrates are substantially the same. The capacitance depends primarily on the relative area between the two plates.

In the embodiment of the present disclosure, the storage capacitor Cst is consisted of the common electrode 31 and the pixel electrode 32. Therefore, the capacitance value of the storage capacitor Cst may be adjusted by adjusting the area of the common electrode 31 and/or the pixel electrode 32. However, since the pixel electrodes 32 have a relatively large impact on the display, different sizes of the pixel electrodes 32 easily cause a display abnormality. Therefore, the area of the common electrode 31 is mainly adjusted in the embodiment of the present disclosure.

Specifically, the area of the common electrode 31 of the storage capacitor Cst with a larger capacitance value is greater than the area of the common electrode 31 of the storage capacitor Cst with a smaller capacitance value.

When the sub-pixels 30 in the same column are electrically connected to the same data line DL, the area of the common electrode 31 of each of the plurality sub-pixels 30 in the same column is equal. Therefore, the area of the common electrode 31 may be adjusted in columns, so as to simplify the process.

Certainly, when the sub-pixels 30 in the same column are electrically connected to different data lines DL, as long as it is ensured that the area of the common electrode 31 of each of the sub-pixels 30 controlled by the same control signal line 11 is equal, which is not described in detail herein.

Further, when the area of the common electrode 31 is adjusted, the common voltages Vcom connected with the plurality of common electrodes 31 may be set to be the same. Specifically, the display panel 100 further includes a common voltage wiring 40. The common voltage wiring 40 is configured to provide a common voltage Vcom. The common voltage wiring 40 includes a first wiring 41 and a plurality of second wirings 42. The first wiring 41 extends in the first direction X. The first wiring 41 may be disposed on a side of the sub-pixel 30 close to the control signal line 11, or may be disposed on a side of the sub-pixel 30 far away from the control signal line 11. Each of the plurality of second wirings 42 is electrically connected to the first wiring 41. The plurality of second wirings 42 are arranged in the first direction X. That is, the second wirings 42 may be disposed in parallel with the data line DL. Each of the second wirings 42 is disposed between two adjacent columns of sub-pixels 30. Each column of sub-pixels 30 is electrically connected to the same second wiring 42.

Therefore, it is ensured that the common voltage Vcom received by each of the sub-pixels 30 is equal. The difference in the data voltage Da due to the different coupling effects is compensated only by adjusting the capacitance value of the storage capacitor Cst, so as to reduce a charging difference of each of the sub-pixels 30.

On the other hand, the deflection angle of the liquid crystal may affect a brightness of the sub-pixel 30. The deflection angle of the liquid crystal depends on a voltage difference between the common electrode 31 and the pixel electrode 32. Ideally, the voltage of the pixel electrode 32 is the data voltage Da received by the sub-pixel 30. However, since the data voltages Da transmitted on the different data lines DL are subjected to different coupling effects, a deflection angle of the liquid crystal may be affected.

Generally, when a display picture of the display panel 100 includes a positive frame and a negative frame, that is, the first frame of display picture is displayed, the sub-pixel 30 receives the positive polarity data voltage. When the next frame display picture is displayed, the sub-pixel 30 receives the negative polarity data voltage. Generally, the common voltage Vcom is set to be in the middle of both the positive polarity data voltage and the negative polarity data voltage, so that the deflection voltage difference of the liquid crystal in the positive and negative frames is the same, thereby performing a normal display. However, as shown in FIG. 3, due to the existence of the coupling capacitance, the feeder voltage Vft results in the voltage difference between the positive polarity data voltage and the negative polarity data voltage received by the sub-pixels 30, so that the common voltage Vcom is not set in the middle of both the positive polarity data voltage and the negative polarity data voltage, thereby causing an abnormal display flash screen.

Specifically, as shown in FIG. 2, for a positive polarity sub-pixel, the larger the feeder voltage Vft is, the darker the pixel is. For a negative polarity sub-pixel, the larger the feeder voltage Vft is, the brighter the pixel is. That is, for the positive polarity sub-pixel, the larger a coupling voltage is, the smaller a difference between the received data voltage Da and the common voltage Vcom is. For the negative polarity sub-pixel, the larger the coupling voltage is, the larger a difference between the received data voltage Da and the common voltage Vcom is.

Therefore, the common voltage Vcom received by the common electrode 31 may be adjusted, so that the common voltage Vcom is still set in the middle of both the positive polarity data voltage and the negative polarity data voltage after subjected to the coupling effect, so as to resolve the problem of the flash screen.

Specifically, it can be known from the foregoing that, for a positive polarity sub-pixel, the larger the feeder voltage Vft is, the darker the pixel is. For a negative polarity sub-pixel, the larger the feeder voltage Vft is, the brighter the pixel is. That is, for the positive polarity sub-pixel, the larger a coupling voltage is, the smaller a difference between the received data voltage Da and the common voltage Vcom is. For the negative polarity sub-pixel, the larger the coupling voltage is, the larger a difference between the received data voltage Da and the common voltage Vcom is.

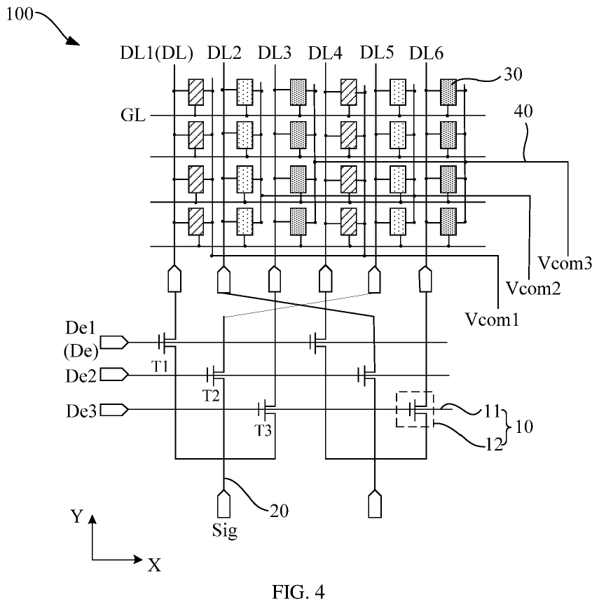

Specifically, referring to FIGS. 2 and 4, FIG. 4 is a schematic diagram of a second partial structure of a display panel according to the present disclosure. This embodiment of the present disclosure is different from the display panel 100 shown in FIG. 1 in that the display panel 100 includes a plurality of common voltage wirings 40.

The plurality of common voltage wrings 40 are respectively configured to provide common voltages Vcom with different voltage values, for example, a first common voltage Vcom1, a second common voltage Vcom2, and a third common voltage Vcom3. Each of the first common voltage Vcom1, the second common voltage Vcom2, and the third common voltage Vcom3 may be adjusted by a power supply chip.

Specifically, the plurality of data lines DL include the first data line and the second data line. The first data line intersects with m control signal lines 11. The second data line intersects with n control signal lines 11. Where, 0≤m<n. The values of m and n depend on the number of control signal lines 11. When three control signal lines 11 are provided, m may be 0 or 1, and n may be 1 or 2. The foregoing content can be specifically referred to, which is not described in detail herein.

Because m<n, a coupling effect on the data voltage Da transmitted on the first data line is less than the coupling effect on the data voltage Da transmitted on the second data line. Therefore, the common voltage Vcom connected with the common electrode 31 of the sub-pixel 30 connected to the first data line may be configured to be greater than the common voltage Vcom connected with the common electrode 31 of the sub-pixel 30 connected to the second data line, where, 0≤m<n.

The values of m and n depend on the number of control signal lines 11. When three control signal lines 11 are provided, m may be 0 or 1, and n may be 1 or 2. The foregoing content can be specifically referred to, which is not described repeatedly herein.

It should be understood that the deflection angle of the liquid crystal may affect brightness of the sub-pixel 30. The deflection angle of the liquid crystal depends on a voltage difference between the common electrode 31 and the pixel electrode 32. Ideally, the voltage of the pixel electrode 32 is the data voltage Da received by the sub-pixel 30. However, since the data voltages Da transmitted by the different data lines DL are subjected to different coupling effects, a deflection angle of the liquid crystal may be affected. Therefore, the difference in the data voltages Da due to the different coupling effects can be compensated by changing the value of the common voltage Vcom, so as to reduce a charging difference of each of the sub-pixels 30.

Specifically, a coupling effect on the data voltage Da transmitted on the first data line is less than a coupling effect on the data voltage Da transmitted on the second data line. Therefore, the common voltage Vcom connected with the common electrode 31 of the sub-pixel 30 connected to the first data line may be configured to be greater than the common voltage Vcom connected with the common electrode 31 of the sub-pixel 30 connected to the second data line.

Further, when a display picture of the display panel 100 generally includes a positive frame and a negative frame, that is, the first frame of display picture is displayed, the sub-pixel 30 receives the positive polarity data voltage. When the next frame display picture is displayed, the sub-pixel 30 receives the negative polarity data voltage. Generally, the common voltage Vcom is set to be in the middle of both the positive polarity data voltage and the negative polarity data voltage, so that the deflection voltage difference of the liquid crystal in the positive and negative frames is the same, thereby performing a normal display. However, as shown in FIG. 3, due to the existence of the coupling capacitance, the feeder voltage Vft results in the voltage difference between the positive polarity data voltage and the negative polarity data voltage received by the sub-pixels 30, so that the common voltage Vcom is not set in the middle of both the positive polarity data voltage and the negative polarity data voltage, thereby causing an abnormal display flash screen.

Therefore, the common voltage Vcom received by the common electrode 31 may be adjusted, so that the common voltage Vcom is still set in the middle of both the positive polarity data voltage and the negative polarity data voltage after subjected to the coupling effect, so as to resolve the problem of the flash screen.

Specifically, it can be known from the foregoing that, for a positive polarity sub-pixel, the larger the feeder voltage Vft is, the darker the pixel is. For a negative polarity sub-pixel, the larger the feeder voltage Vft is, the brighter the pixel is. That is, for the positive polarity sub-pixel, the larger a coupling voltage is, the smaller a difference between the received data voltage Da and the common voltage Vcom is. For the negative polarity sub-pixel, the larger the coupling voltage is, the larger a difference between the received data voltage Da and the common voltage Vcom is.

Therefore, the common voltage Vcom can be set right in the middle of both the positive polarity data voltage and the negative polarity data voltage, so as to improve the display quality.

In the embodiments of the present disclosure, the number of the common voltage wirings 40 is the same as that of the control signal lines 11. The plurality of sub-pixels 30 controlled by the same control signal line 11 are electrically connected to the same common voltage wiring 40.

The plurality of data lines DL controlled by the same control signal line 11 are subjected to the same coupling effect. That is, the data voltage Da received by each of the plurality of sub-pixels 30 controlled by the same control signal line 11 is subjected to the same coupling effect. Therefore, the plurality of sub-pixels 30 controlled by the same control signal line 11 can share the same common voltage Vcom, thereby reducing the number of common voltage wirings 40.

Similarly, when the received common voltage Vcom of the common electrode 31 is adjusted, the plurality of common electrodes 31 can be configured to have the same area.

It should be noted that, in other embodiment of the present disclosure, the capacitance value of the storage capacitor Cst and the common voltage Vcom received by the common electrode 31 can be also adjusted simultaneously when the coupling effects of the data voltages Da received by different data lines DL have larger difference, thereby reducing a charging difference among the plurality of sub-pixels 30 and improving the display uniformity of the display panel 100.

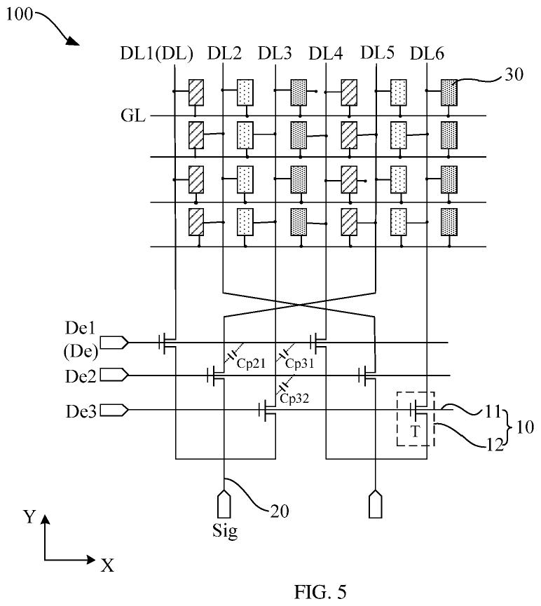

Please refer to FIG. 5, which is a schematic diagram of a third structure of a display panel according to the present disclosure. A difference from the display panel 100 shown in FIG. 1 lies in that in this embodiment of the present disclosure, in the first direction X, two adjacent data lines DL are configured to transmit the data voltages Da having opposite polarities, and two adjacent sub-pixels 30 have opposite polarities. The capacitance value of the storage capacitor Cst and the common voltage Vcom connected with the common electrode 31 of each of the sub-pixels 30 controlled by the same control signal line 11 are equal.

That is, the display panel 100 in the embodiment of the present disclosure adopts a 1-dot inversion driving mode, so as to further improve a display quality of the display panel 100. Certainly, this embodiment of the present disclosure is not limited thereto. In another embodiment, the display panel 100 may also adopt a 2-dot inversion driving mode, which is not described repeatedly herein.

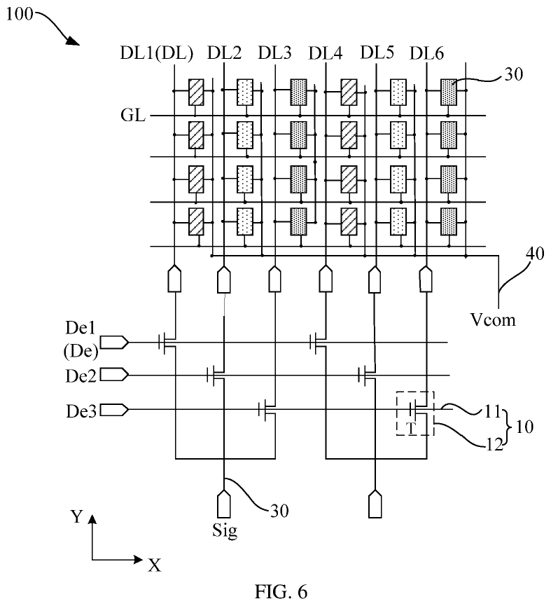

Please refer to FIG. 6, which is a schematic diagram of a fourth structure of a display panel according to the present disclosure. A difference from the display panel 100 shown in FIG. 1 lies in that in this embodiment of the present disclosure, two adjacent data lines DL are configured to transmit the data voltages Da having opposite polarities. Each of the signal transmission lines 20 is configured to alternatively transmit the data voltages Da having the opposite polarities. Every adjacent k data lines are electrically connected to the same signal transmission line 20 by a corresponding control unit 12, where k is greater than or equal to 2.

The value of k depends on the number of control signal lines 11. Generally, the value of k is the same as the number of control signal lines 11. For example, in this embodiment of the present disclosure, three control signal lines 11 can be provided. Every adjacent 3 data lines are electrically connected to the same signal transmission line 20 by a corresponding control unit 12.

In this embodiment of the present disclosure, each of the signal transmission lines 20 can be configured to alternately transmit the data voltages Da having opposite polarities. Therefore, it can be implemented that two adjacent data lines DL are configured to transmit the data voltages Da having opposite polarities, thereby avoiding intersection of the plurality of data lines DL and reducing the difficulty of the process. The occurrence of signal coupling is also avoided.

Accordingly, the present disclosure further provides a display device, including a display panel and a source driving chip. The display panel is the display panel 100 in any one of the foregoing embodiments, which are not repeatedly described herein. The source driving chip is configured to provide the data voltage to the display panel.

In addition, the display device may be a smartphone, a tablet computer, an e-book reader, a smartwatch, a camera, a game machine, or the like. This is not limited in the present disclosure.

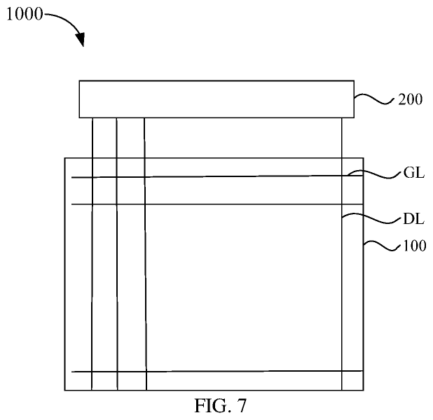

Specifically, please refer to FIG. 7, which is a schematic structural diagram of a display device according to the present disclosure. The display device 1000 includes a display panel 100 and a source driving chip 200.

The liquid crystal display panel 100 includes a plurality of scanning lines GL and a plurality of data lines DL. The plurality of data lines DL are arranged in the first direction X. The plurality of scanning lines GL are arranged in the second direction Y. The display panel 100 further includes a plurality of sub-pixels (not labeled in FIGs), and each sub-pixel is electrically connected to a corresponding scanning line GL and a corresponding data line DL.

In the second direction Y, the source driving chip 200 may be disposed above the display panel 100, or may be disposed below the display panel 100. At least one of source driving chip 200 may be provided. The source driving chip 200 transmits a data signal to the display panel 100 via the data line DL. In some embodiments, the source driving chip 200 may be bound to the display panel 100 by a COF (Chip On Film). This is not specifically limited in the present disclosure.

Optionally, in the display device 1000 in this embodiment of the present disclosure, the plurality of data lines DL are electrically connected to the source driving chip 200 in the first direction X by a Demux circuit. As a result, the number of the output channels of the source driving chip 200 can be reduce manyfold, thereby reducing the number of source driving chips 200 and reducing costs.

The display device 1000 in the embodiment of the present disclosure includes the display panel 100. In the display panel 100, the capacitance value of the storage capacitor and/or the common voltage connected to the common electrode of each of the sub-pixels can be adjusted according to the different coupling effects of the data voltages received from different data lines DL, so as to compensate for a difference of data voltage due to the different coupling effects. As a result, a charging difference between the sub-pixels can be reduced, thereby improving the display uniformity of the display panel 100 and further the quality of the display device 1000.

The display panel and the display device provided in the embodiments of the present disclosure are described in detail above. Specific embodiments are used herein to describe a principle and an implementation of the present disclosure. The description of the foregoing embodiments is merely used to help understand a method and a core idea of the present disclosure. In addition, an ordinary person skilled in the art may make changes in a specific implementation manner and an application scope according to an idea of the present disclosure. In conclusion, content of this specification should not be construed as a limitation on the present disclosure.

What is claimed is:

1. A display panel, comprising:
a plurality of data lines arranged in a first direction;
a Demux circuit including at least two control signal lines and a plurality of control units, wherein, the at least two control signal lines are arranged in a second direction, each of the control signal lines is electrically connected to corresponding one of the control signal lines and corresponding one of the data lines, and the first direction intersects the second direction;
a plurality of signal transmission lines arranged in the first direction, wherein each of the signal transmission lines is electrically connected to the at least two control units; and
a plurality of sub-pixels arranged in an array, wherein each of the sub-pixels includes a pixel electrode and a common electrode, the pixel electrode and the common electrode are laminated and insulated to form a storage capacitor, and each of the pixel electrodes is electrically connected to a corresponding data line;
wherein, the data lines are disposed at a different layer from the control lines, a portion of the data lines intersects with at least one of the control signal lines, and a capacitance value of the storage capacitor and/or a common voltage connected with the common electrode of the sub-pixel are/is adjusted according to the number of times for which the corresponding data line intersects with the plurality of control signal lines.

2. The display panel of claim 1, wherein the sub-pixels in the same column are electrically connected to the same data line in the first direction, and the capacitance value of the storage capacitor and the common voltage connected with the common electrode of each of the sub-pixels in the same column are equal.

3. The display panel of claim 1, wherein, in the first direction, two adjacent data lines of the data lines are configured to transmit data voltages having opposite polarities, two adjacent sub-pixels of the sub-pixels have opposite polarities, and the capacitance value of the storage capacitor and the common voltage connected to the common electrode of each of the sub-pixels controlled by the same control signal line are equal.

4. The display panel of claim 1, wherein the plurality of data lines include a first data line intersecting with m control signal lines of the control signal lines and a second data line intersecting with n control signal lines of the control signal lines, wherein 0≤m<n;
when a positive polarity data voltage is outputted from the signal transmission line, the capacitance value of the storage capacitor of the sub-pixel connected to the first data line is less than the capacitance value of the storage capacitor of the sub-pixel connected to the second data line; and
when a negative polarity data voltage is outputted from the signal transmission line, the capacitance value of the storage capacitor of the sub-pixel connected to the first data line is greater than the capacitance value of the storage capacitor of the sub-pixel connected to the second data line.

5. The display panel of claim 4, wherein a plurality of the common electrodes is connected with the same common voltage.

6. The display panel of claim 4, wherein an area of the common electrode of the storage capacitor with a larger capacitance value is greater than an area of the common electrode of the storage capacitor with a smaller capacitance value.

7. The display panel of claim 6, wherein a plurality of the common electrodes is connected with the same common voltage.

8. The display panel of claim 7, wherein each of common voltage wirings includes a first wiring and a plurality of second wiring connected to the first wiring, the first wiring extends in the first direction, the plurality of second wirings are arranged in the first direction, each of the second wirings is disposed between two adjacent columns of the sub-pixels, and the sub-pixels in the same column are electrically connected to the same second wiring.

9. The display panel of claim 1, wherein the plurality data lines include a first data line intersecting with m control signal lines of the control signal lines and a second data line intersecting with n control signal lines of the control signal lines, and the common voltage connected with the common electrode of the sub-pixel connected to the first data line is greater than the common voltage connected with the common electrode of the sub-pixel connected to the second data line, wherein 0≤m<n.

10. The display panel of claim 9, wherein the display panel further includes a plurality of common voltage wirings, each of the common voltage wirings transmits a different common voltage, and the number of the common voltage wirings is the same as that of the control signal wirings; and
a plurality of the sub-pixels controlled by the same control signal line are electrically connected to the same common voltage wiring.

11. The display panel of claim 1, wherein each of the control units includes a thin film transistor, a gate thereof is electrically connected to a corresponding control signal line, a source thereof is electrically connected to a corresponding signal transmission line, and a drain thereof is electrically connected to a corresponding data line; and
channel aspect ratios of the thin film transistors in the plurality of control units are equal.

12. The display panel of claim 1, wherein two adjacent data lines of the data lines are configured to transmit data voltages having opposite polarities, each of the signal transmission lines is configured to transmit data voltages having the same polarity, and each of the data line is electrically connected to a corresponding signal transmission line via one of the control units.

13. The display panel of claim 1, wherein two adjacent data lines of the data lines are configured to transmit data voltages having opposite polarities, each of the signal transmission lines is configured to alternately transmit data voltages having opposite polarities, and every k adjacent data lines of the data lines are electrically connected to the same signal transmission line via a corresponding control unit, wherein k is greater than or equal to 2.

14. A display device, comprising a display panel and a source driving chip for providing a data voltage to the display panel, wherein the display panel comprises:
a plurality of data lines arranged in a first direction;
a Demux circuit including at least two control signal lines and a plurality of control units, wherein, the at least two control signal lines are arranged in a second direction, each of the control signal lines is electrically connected to corresponding one of the control signal lines and corresponding one of the data lines, and the first direction intersects the second direction;
a plurality of signal transmission lines arranged in the first direction, wherein each of the signal transmission lines is electrically connected to the at least two control units; and
a plurality of sub-pixels arranged in an array, wherein each of the sub-pixels includes a pixel electrode and a common electrode, the pixel electrode and the common electrode are laminated and insulated to form a storage capacitor, and each of the pixel electrodes is electrically connected to a corresponding data line;
wherein, the data lines are disposed at a different layer from the control lines, a portion of the data lines intersects with at least one of the control signal lines, and a capacitance value of the storage capacitor and/or a common voltage connected with the common electrode of the sub-pixel are/is adjusted according to the intersection times of the corresponding data line with the plurality of control signal lines;
the sub-pixels in the same column are electrically connected to the same data line in the first direction, and the capacitance value of the storage capacitor and the common voltage connected with the common electrode of each of the plurality of sub-pixels in the same column are equal.

15. The display device of claim 14, wherein two adjacent data lines of the data lines are configured to transmit data voltages having opposite polarities in the first direction, two adjacent sub-pixels of the sub-pixels have opposite polarities, and the capacitance value of the storage capacitor and the common voltage connected with the common electrode of each of the sub-pixels controlled by the same control signal line are equal.

16. The display device of claim 14, wherein the plurality of data lines include a first data line intersecting with m control signal lines of the control signal lines and a second data line intersecting with n control signal lines of the control signal lines, wherein 0≤m<n;
when a positive polarity data voltage is outputted from the signal transmission line, the capacitance value of the storage capacitor of the sub-pixel connected to the first data line is less than the capacitance value of the storage capacitor of the sub-pixel connected to the second data line; and
when a negative polarity data voltage is outputted from the signal transmission line, the capacitance value of the storage capacitor of the sub-pixel connected to the first data line is greater than the capacitance value of the storage capacitor of the sub-pixel connected to the second data line.

17. The display device of claim 16, wherein a plurality of the common electrodes is connected with the same common voltage.

18. The display device of claim 16, wherein an area of the common electrode of the storage capacitor with a larger capacitance value is greater than an area of the common electrode of the storage capacitor with a smaller capacitance value.

19. The display device of claim 18, wherein each of common voltage wirings includes a first wiring and a plurality of second wiring connected to the first wiring, the first wiring extends in the first direction, the plurality of second wirings are arranged in the first direction, each of the second wirings is disposed between two adjacent columns of sub-pixels, and the sub-pixels in the same column are electrically connected to the same second wiring.

20. The display device of claim 14, wherein the plurality data lines include a first data line intersecting with m control signal lines of the control signal lines and a second data line intersecting with n control signal lines of the control signal lines, and the common voltage connected with the common electrode of the sub-pixel connected to the first data line is greater than the common voltage connected with the common electrode of the sub-pixel connected to the second data line, wherein, 0≤m<n.
